(19) United States
(12) Patent Application Publication
(10) Pub. No.: US 2008/0110099 A1
(43) Pub. Date: May 15, 2008

(54) Interior storm window and method for attaching same

(75) Inventors: Joseph Famulare, Richmond Hill, NY (US); Eugene Orange, Richmond Hill, NY (US); Angelo Alfieri, Richmond Hill, NY (US)

Correspondence Address: COLLARD & ROE, P.C., 1077 NORTHERN BOULEVARD, ROSLYN, NY, 11576, US

(73) Assignee: ULTRA SASH WINDOW FACTORY, INC.

(21) Appl. No.: 11/599,076

(22) Filed: Nov. 14, 2006

(51) Int. Cl. E05C 21/02; A47G 29/00

(52) U.S. Cl. 49/465; 248/200; 49/506

(57) ABSTRACT

An interior storm window assembly has an outer frame adapted to be attached to an existing window frame or wall and having a channel running around an interior surface thereof, and a window unit comprising an inner frame surrounding a window pane. The window unit is adapted to be snap-fit inside the outer frame so that the window unit is securely held within the outer frame without play. There is a locking device for locking the window unit within the outer frame. The outer frame is attached to an existing window frame or to a wall surface surrounding an existing window, to provide an extra layer of protection against hurricane-force winds.

### BACKGROUND OF THE INVENTION

1. Field of the Invention

This invention relates to a storm window that is applied on the interior of a standard window frame. In particular, the invention relates to a storm window that is easily removable and yet provides secure protection in the event of severe weather.

2. The Prior Art

Most storm windows that are made to withstand hurricane-force winds are applied to the exterior of a window unit. These storm windows are often heavy and cumbersome, and require professional installation and removal. In addition, they prevent the user from opening the window to let in fresh air. Another type of storm protection comes from hurricane shutters, which consist of heavy plates of metal that are pulled over the window during a storm. These shutters are difficult and expensive to install, and are not attractive, even when raised.

### SUMMARY OF THE INVENTION

It is therefore an object of the invention to provide a method and device for protecting windows and the interior of a dwelling from hurricane-force winds, that is inexpensive, simple to install and remove, and which does not detract from the appearance of the window.

These and other objects are accomplished by an interior storm window assembly comprising an outer frame adapted to be attached to an existing window frame or wall and having a channel running around an interior surface thereof, and a window unit comprising an inner frame surrounding a window pane. The window unit is adapted to be snap-fit inside the outer frame so that the window unit is securely held within the outer frame without play. There is a locking device for locking the window unit within the outer frame. The outer frame is attached to an existing window frame or to a wall surface surrounding an existing window, to provide an extra layer of protection against hurricane-force winds.

The locking device preferably comprises a steel bar mounted within both sides of the inner frame, and a bracket mounted to the steel bar via a screw. The bracket can be rotated to extend past the sides of the inner frame to brace the window unit against the outer frame when the window unit is mounted in the outer frame. The screws are tightened when the bracket is in place to keep the window unit securely mounted.

There is preferably insulation mounted around a periphery of the window unit to further seal the window unit in the frame.

The window pane is preferably formed of storm-resistant glass, also called impact-resistant glass. Storm-resistant glass consists of two layers of glass surrounding a strong layer of impact-resistant material. Alternatively a layer of glass can be coated with a layer of impact resistant material. This way, strong winds and flying debris are prevented from breaking the glass and entering the dwelling.

The window unit is snap-fit into the outer frame due to a flexible insert located inside the channel on the bottom of the outer frame. The flexible insert bends under pressure during installation of the window unit, and flexes against the window unit after the window unit is installed in the outer frame, to keep the window unit inside the outer frame.

There is preferably a flange extending along the inner frame below the window pane, to assist the user in installing and removing the window unit from the outer frame. The flange can be used for leverage in trying to raise and lower the window unit within the outer frame to clear the boundaries of the outer frame.

To use the window assembly, the outer frame is first installed on top of an interior of a window frame or to a wall surrounding the window frame. This is usually done with bolts or screws, but other methods could be envisioned. The window unit is then snapped into the outer frame. Finally, the window unit is secured to the outer frame using the brackets.

When the window unit is installed over a window, the pane is preferably located between 1 and 3 inches from a pane of the window. This is an optimum distance to provide storm protection and insulation, and yet still allow access to the original window when the storm window unit is not installed.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a front view of one embodiment of the interior storm window according to the invention;

FIG. 2 shows a perspective view of the window unit of the storm window;

FIG. 3 shows a perspective view of the outer frame;

FIG. 4 shows a view of a section of the outer frame showing the holding bracket embedded in a steel bar within the outer frame;

FIG. 5 shows a view of the interior storm window assembly as mounted on an existing window frame; and

FIG. 6 shows a view of the bottom section of the outer frame.

### DETAILED DESCRIPTION OF THE PREFERRED EMBODIMENT

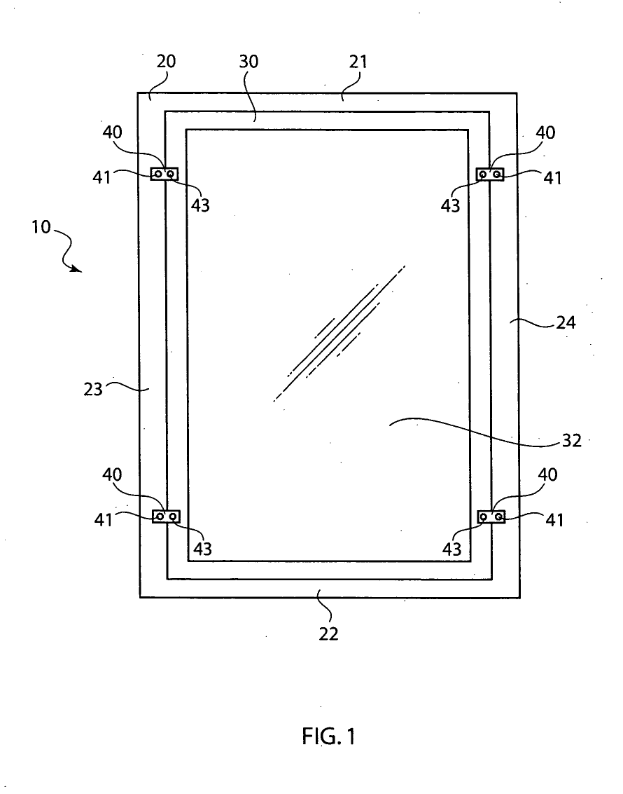

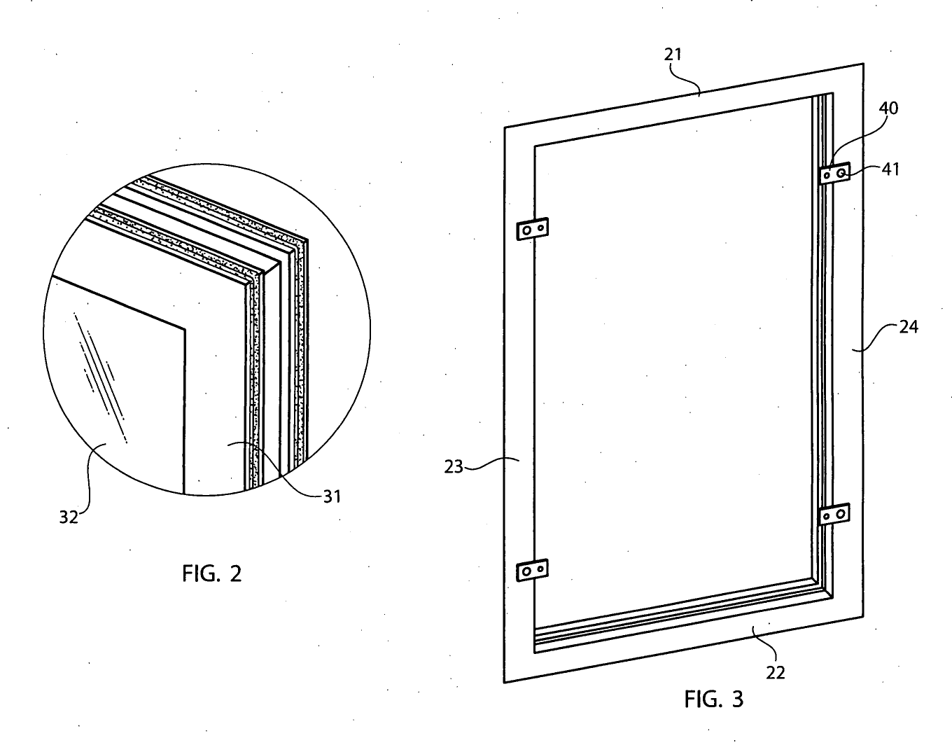

Referring now in detail to the drawings, FIGS. 1-3 show one embodiment of the interior storm window assembly according to the invention. Storm window assembly 10 comprises an outer frame 20 and a window unit 30. Outer frame 20 has an upper side 21, a lower side 22, a left side 23 and a right side 24. Window unit 30 comprises an inner frame 31, which surrounds a pane of glass 32. Inner frame 31 has a channel running around its outer periphery. Insulation 35 is also placed around the peripheral edges of window unit 30. Glass 32 is preferably high-strength storm-resistant glass. There is a flange 37 extending along a bottom section of window unit 30 to aid in the installation and removal of window unit 30 from outer frame 20.

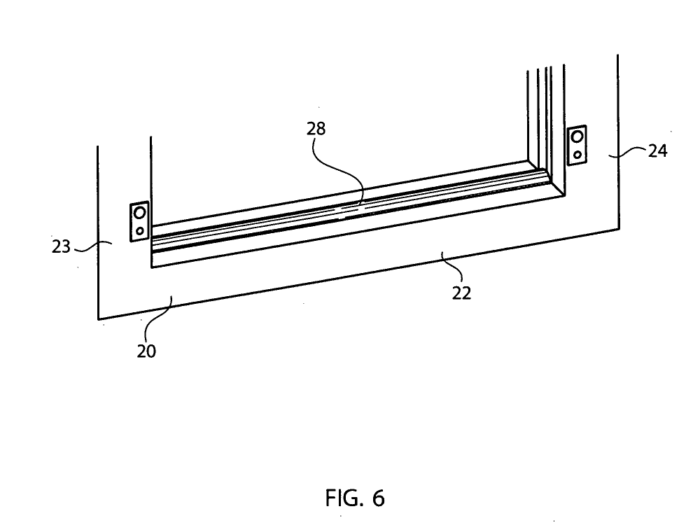

Outer frame 20 has indentations extending along an inner surface of each of its sides, top and bottom, for holding window unit 30 therein. Window unit 30 is snapped into place within outer frame 20 when in use. A flexible insert 28 is inserted into the bottom of outer frame 20 and helps to keep window unit 30 in place, as shown in FIG. 6. Insert 28 flexes as window unit 30 is inserted and allows window unit 30 to be fully inserted into outer frame 20. Once window unit 30 is fully inserted, insert 28 flexes against window unit 30 to keep it in place.

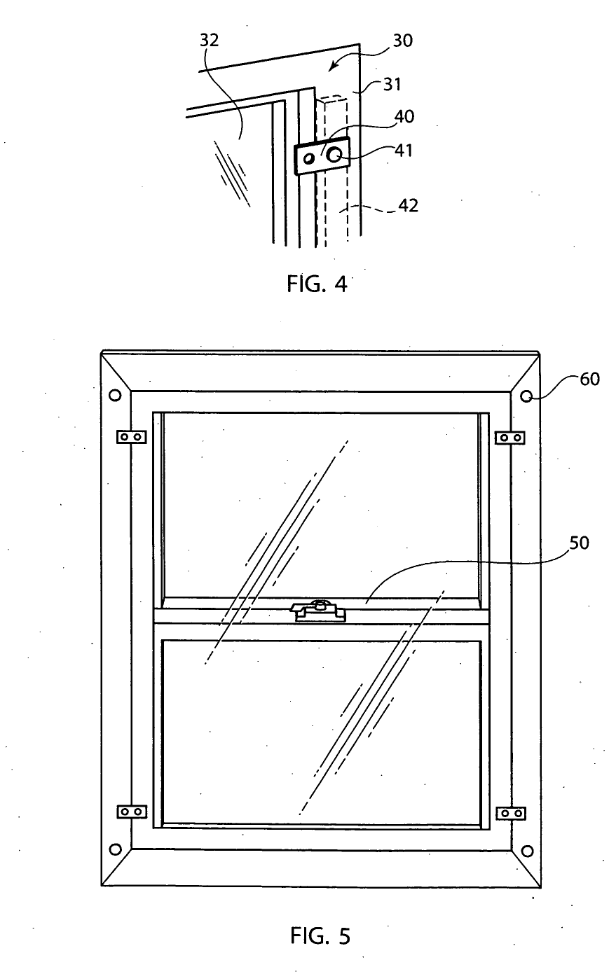

A steel bar 42 is embedded along each side of outer frame 20, as shown in FIG. 4. Attached to each steel bar 42 is a set of brackets 40 held in place by screws 41 and 43 on each of outer frame 20 and window unit 30, respectively. Brackets 40 help to keep window unit 30 in place within outer frame 20, even during hurricane-force winds.

To use assembly 10, outer frame 20 is secured to a wall or window frame, to surround an existing window 50, as shown in FIG. 5. This can be done via screws, brackets or any other conventional securing method. The window assembly according to the invention prevents water and wind damage to buildings during strong storms, yet is easily removable by simply popping out the window unit. The outer frame can remain mounted over the window, because it still enables access to the original window for opening and closing the window during regular weather patterns.

Accordingly, while only a few embodiments of the present invention have been shown and described, it is obvious that many changes and modifications may be made thereunto without departing from the spirit and scope of the invention.

What is claimed is:

1. An interior storm window assembly, comprising:
an outer frame adapted to be attached to an existing window frame or wall, said outer frame having a top piece, a bottom piece, and two side pieces, all connected together to create a rectangular frame, said outer frame having a channel running around an interior surface thereof;
a window unit comprising an inner frame surrounding a window pane, said window unit adapted to be snap-fit inside the outer frame so that said window unit is securely held within the outer frame without play;
a locking device for locking the window unit within the outer frame; and
means for attaching the outer frame to a surface.

2. The window assembly according to claim 1, wherein the locking device comprises a steel bar mounted within both sides of the inner frame, and a bracket mounted to the steel bar via a screw, said bracket extending past the sides of the inner frame and bracing the window unit against the outer frame when said window unit is mounted in the outer frame.

3. The window assembly according to claim 1, further comprising insulation mounted around a periphery of the window unit.

4. The window assembly according to claim 1, wherein the window pane is formed of storm-resistant glass.

5. The window assembly according to claim 1, further comprising a flexible insert located inside the channel on the bottom of the outer frame, said flexible insert bending under pressure during installation of said window unit, and flexing against said window unit after said window unit is installed in the outer frame, to keep the window unit inside the outer frame.

6. The window assembly according to claim 1, further comprising a flange extending along the inner frame below the window pane, said flange assisting the user in installing and removing the window unit from the outer frame.

7. A method for reinforcing windows against storm damage, comprising:
installing an outer frame to an interior of a window frame or to a wall surrounding the window frame;
installing a window unit within the outer frame, said window unit having an inner frame and a pane installed within the inner frame; and
securing the window unit within the outer frame.

8. The method according to claim 7, wherein when the window unit is installed over a window, the pane is located between 1 and 3 inches from a pane of the window.

9. The method according to claim 7, wherein the inner frame has steel bars extending along its side walls, and brackets mounted to said steel bars, and wherein said step of securing the window unit to the outer frame comprises turning the brackets to a position where said brackets overlap the outer frame, and tightening the brackets so that the brackets press against the outer frame.

10. The method according to claim 7, wherein said step of installing the outer frame comprises attaching the outer frame to the window frame or wall using bolts or screws.

11. The method according to claim 7, wherein the pane is made of storm-resistant glass.

12. The method according to claim 7, wherein the step of installing the window unit comprises inserting the window unit into a channel in the outer frame, and pressing on a flexible insert disposed on the bottom of the outer frame until the window unit is fully inserted into the channel, wherein the flexible insert flexes against the window unit and holds the window unit in the frame.
